(19) United States
(12) Patent Application Publication
(10) Pub. No.: US 2010/0180833 A1
(43) Pub. Date: Jul. 22, 2010

(54) DOG TRAINING BUMPER COVER SUITABLE FOR WATER TRAINING

(76) Inventor: Seth Ohms, Cedar City, UT (US)

Correspondence Address: THORPE NORTH & WESTERN, LLP., P.O. Box 1219, SANDY, UT, 84091-1219, US

(21) Appl. No.: 12/690,413

(22) Filed: Jan. 20, 2010

Related U.S. Application Data
(60) Provisional application No. 61/145,884, filed on Jan. 20, 2009.

(51) Int. Cl. A01K 15/02

(52) U.S. Cl. 119/707; 119/712

(57) ABSTRACT

A dog training bumper cover having a porous manufactured sleeve is disclosed and described. The porous manufactured sleeve can have an inner surface and an outer surface. A layer of feathers can be attached to the outer surface via an attachment member. The feathers can be attached in either a random or imbricate pattern. Further, the sleeve is configured to at least partially cover a corresponding dog training bumper. These bumper covers can allow for substantially improved marking abilities while also providing a reusable training device suitable for use in water environments which can dry quickly sufficient to substantially reduce growth of mildew, fungus or attraction of insects, as well as substantially reduce rot and degradation of the bumper cover.

### RELATED APPLICATION

This application claims priority to U.S. Provisional Application No. 61/145,884, filed Jan. 20, 2009, which is incorporated herein by reference.

### FIELD OF THE INVENTION

This invention relates to devices for dog training More specifically, the invention relates to a bumper cover having feathers attached which can be used for retrieval training of dogs in dry and wet environments while avoiding rapid degradation of the cover. Therefore, the present invention relates generally to the fields of hunting dog training and material science.

### BACKGROUND

Training of hunting dogs can involve extensive effort which extends from early puppy stage throughout the adult life of a hunting dog. A wide range of training techniques can be used which often depend on the goals and preferences of the trainer, as well as the disposition of the individual dog. However, the use of plastic and rubber bumpers has become one of the most highly used retrieval devices, regardless of the particular training system used. These bumpers are generally a polymeric cylindrical object such as the one depicted in FIG. 1, shown generally at 10, and generally formed from plastics such as vinyl or rubber. These bumpers often include bumps 12 or other protrusions which facilitate gripping by the dog's teeth during retrieval, especially in wet environments. A string is often attached at one end (e.g. via an eyelet 14) which allows the trainer to throw the bumper more easily. These bumpers have the advantage of good durability and can withstand extended use in both wet and dry environments. However, these bumpers fail to have the appearance of actual target birds such as pheasants, ducks, etc. Such rubber and plastic bumpers also have a reduced scent retention which makes successful scenting training difficult. As a result, dogs which are extensively trained using these bumpers can become confused regarding the retrieval target during competitions or actual hunting. In particular, retriever competitions routinely involve throwing out bumper dummies (such as plastic or rubber decoys, or bumper-like decoys) and real birds in order to determine whether the dogs can distinguish between the two.

In order to overcome these deficiencies, efforts have been made to provide dummies which have the general appearance of real birds. Most of these products include whole pelts of skinned fowl or have a few individual feathers strapped to a dummy. Others provide a dummy having a bird picture or shape as part of the design. These products have been relatively effective in helping to train dogs to retrieve real birds during competition and hunting. Some such products can also help to improve or reduce mouthing problems by allowing the dog to have a similar feel to a real bird. However, these products have limitations and drawbacks which prevent more extensive use.

### SUMMARY

The present inventor has recognized that the ability to have more life-like training dummies which can withstand repeated and extended use in both wet and dry training environments would be desirable. In particular, conventional dummies currently on the market that utilize fowl pelts are not suitable for wet use. These products can become wet through use in ponds or merely as the result of saturation with dog saliva, and mildew. Under such moist conditions, conventional products tend to degrade and can quickly become unusable as the skin tends to rot and attracts insects and maggots. Furthermore, these conventional dummies tend to be fragile and have a limited usable lifespan as the feathers come loose from the pelt.

In light of the problems and deficiencies noted above, a dog training bumper cover can have a porous manufactured sleeve. The porous manufactured sleeve can have an inner surface and an outer surface. A layer of feathers can be attached to the outer surface via an attachment member. Further, the sleeve can be configured to at least partially cover a corresponding dog training bumper.

The attachment member can be any of a variety of systems, although two are currently particularly suitable. One option for the attachment member is a cord where feathers are secured to the cord. The cord is sewn onto the porous manufactured sleeve. Alternatively, the attachment member can be an adhesive where the feathers are directly adhered to the porous manufactured sleeve.

In order to facilitate different training designs, the arrangement of feathers can be varied. In one aspect, feathers in the layer of feathers can be randomly arranged. Alternatively, the layer of feathers can include feathers oriented substantially all in a common direction similar to the arrangements found on birds.

In accordance with one aspect, feathers can be securely attached to a non-absorbent mesh type fabric. This allows for multiple uses without degradation of the product. After use in a water environment the bumper cover can be removed from the bumper/dummy and dried by air drying or machine drying. Also, under the appropriate climatic conditions the bumper covers of the present invention can dry completely while yet remaining on the bumper/dummy, if hung in an open area indoors or out. Low humidity is a strong indicator of decreased drying times, although higher temperatures can also decrease drying times. Once dry, the bumper covers can be stored without degradation, or be reused for continued dog training.

There has thus been outlined, rather broadly, some features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention and they are, therefore, not to be considered limiting of its scope. It will be readily appreciated that the components of the present invention, as generally described and illustrated in the figures herein, could be arranged, sized, and designed in a wide variety of different configurations. Nonetheless, the invention will be described and explained with additional specificity and detail through the use of the accompanying drawings in which:

FIG. 1 is a bumper representative of conventional prior art bumpers which can be used in connection with embodiments of the present invention.

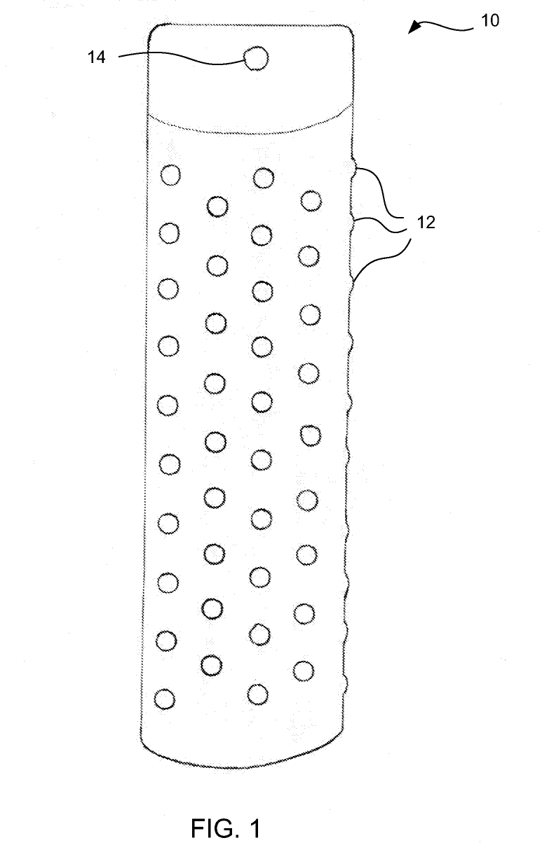

FIG. 2 is a schematic perspective view of a bumper cover having a random arrangement of feathers in accordance with one embodiment of the present invention.

FIG. 3 is a schematic perspective view of a cone bumper cover having a bird dummy placed therein in accordance with another embodiment of the present invention.

FIG. 4 is a schematic perspective view of the cone bumper cover of FIG. 3 with the end drawn closed.

FIG. 5 is a schematic perspective view of a bumper cover having an imbricate arrangement of feathers in accordance with one embodiment of the present invention.

FIG. 6 is a schematic perspective view of a bumper being inserted into a bumper cover in accordance with one embodiment of the present invention.

FIG. 7 is a schematic perspective view of a bumper cover tied closed over a bumper in accordance with one embodiment of the present invention.

### DETAILED DESCRIPTION

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

Definitions

In describing and claiming the present invention, the following terminology will be used.

The singular forms “a,” “an,” and “the” include plural referents unless the context clearly dictates otherwise. Thus, for example, reference to “a layer of feathers” includes reference to one or more of such layers and reference to “securing” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Dog Training Bumper Covers

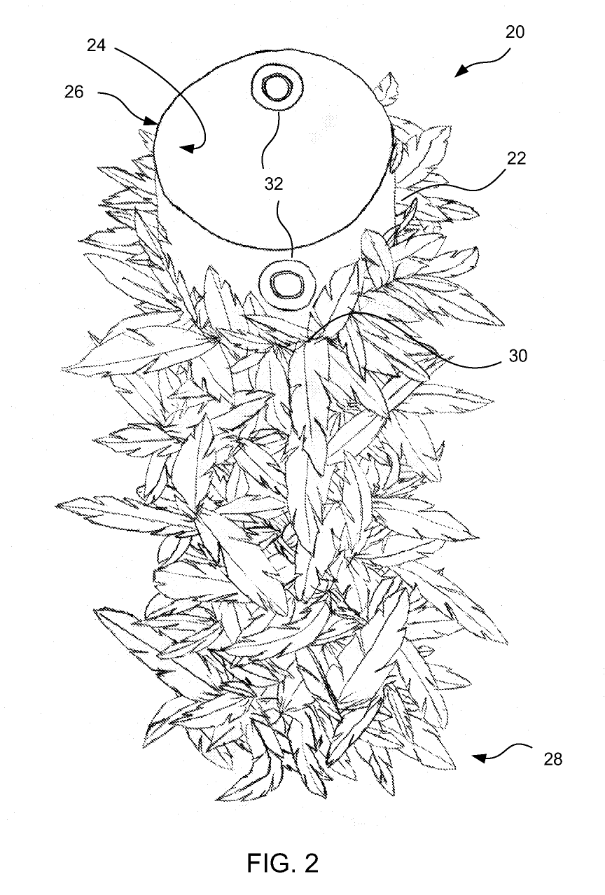

Referring now to FIG. 2, a dog training bumper cover 20 having a porous manufactured sleeve 22 is shown. The porous manufactured sleeve can have an inner surface 24 and an outer surface 26. A layer of feathers 28 can be attached to the outer surface via an attachment member 30. Further, the sleeve is configured to at least partially cover a corresponding dog training bumper.

The porous manufactured sleeve can be formed of a wide variety of materials such as, but not limited to, woven fabric, non-woven fabric, screen material, mesh material, or elastic material. Non-limiting specific examples of suitable material for the porous manufactured sleeve can include woven polyethylene fabric, polypropylene fabric, woven polyester fabric, woven cotton fabric, non-woven polypropylene fabric, and combinations thereof. Some of these products are commercially available as Fabrene®, textiles from Bonar Technical Fabrics (e.g. Bontec), spandex materials, and the like. Currently, one preferred porous manufactured sleeve can be a woven polyethylene fabric.

An advantage of using a porous manufactured sleeve is reduced drying time and reduced water retention. This facilitates training for retrieval of waterfowl such as ducks and geese, as well as upland game such as quail, pheasants, grouse, turkey, etc. Also, the porous and mesh fabric can be non-fraying and can be ultra-violet light resistant such that the bumper covers can be reusable and exhibit extended and rugged durability sufficient to withstand continued and repeated use in outdoor water training situations.

For woven or mesh materials, the porosity can be sufficient to allow simple drying of the material by machine drying or air drying. For example, typically the bumper cover substantially dries within about 12 hours at 25° C. and 50% humidity in an unenclosed environment, and in some cases within about 6 hours. As a general guideline, porosity of the sleeve material can range from about 0.1 mm to 2 mm, although these ranges can vary as long as the drying characteristics are maintained.

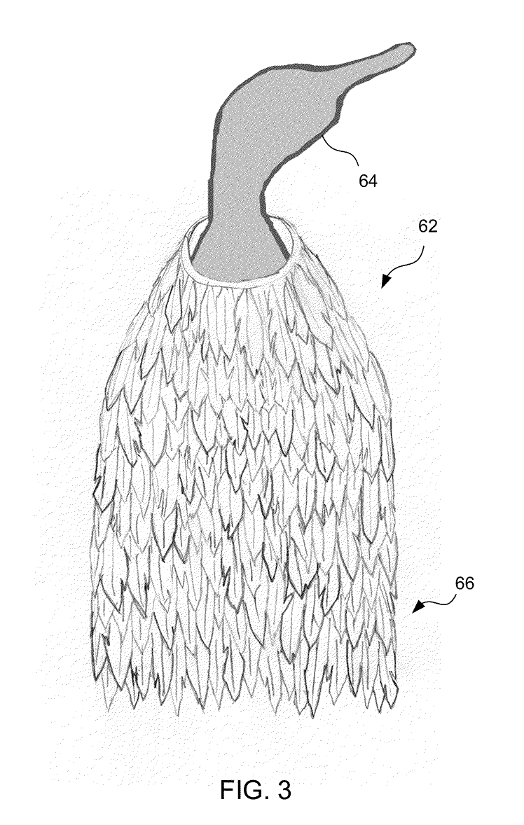

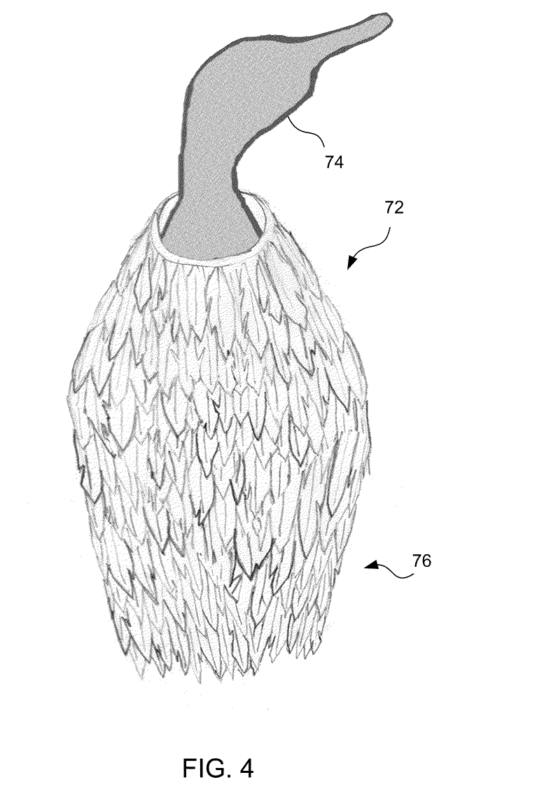

The sleeves can be constructed in a sleeve-like fashion, open on both ends, which allows for integration with the various sizes of the differing retrieving bumper/dummy products and models presently in general use by dog trainers and available from manufacturers. However, the sleeve shape can be configured for enveloping any form of bumper/dummy or decoy. For example, cylindrical sleeves can be suitable for common cylinder shaped bumpers. Size can vary, but depends on the bumper application and dog size, e.g. 3″×12″, 2″×9″, 2″×11″, and 2″×10″ are several common sizes. There are also variations that mimic the form of birds. These bird-shaped dummies vary in size, and are generally cone shaped. FIG. 3 illustrates a cone shaped sleeve 62 configured to cover a bird-shaped dummy 64. In this embodiment the tail end 66 of the sleeve has a straight contour. FIG. 4 illustrates a similar embodiment of a cone-shaped sleeve 72 covering a bird-shaped dummy 74. However, the tail end 76 has an inwardly tapered contour towards the end. FIG. 3 and FIG. 4 are the same cover, where FIG. 4 is after the open end has been closed or reduced by the use of a drawstring (or other mechanism) to ensure the bird-like bumper stays within the cover when used. Furthermore, dummies and decoys can vary considerably in weight and color. Both the cylindrical and cone type may be of differing designs, such as closed ends rather than open and sleeve-like. In one embodiment, the porous manufactured sleeve can be closed at a distal end. However, open ends can facilitate faster drying and reduce collection of debris. In another alternative embodiment, the porous manufactured sleeve can be integral with the corresponding dog training bumper such that the layer of feathers is permanently attached directly to the outer bumper cover surface.

Optionally, the sleeve can include an upper cuff which has a reinforced edge to withstand repeated throwing. The upper cuff can be a continuation of the same material as the sleeve, but without feathers. In this case, the material of the upper cuff and/or sleeve can be double-layered or otherwise reinforced, e.g. sewing additional banded materials. Alternatively, the porous manufactured sleeve can be sewn or otherwise secured to the upper cuff. The upper cuff can generally be an annular ring to coincide with the shape of the sleeve, although other shapes could also be suitable. Non-limiting examples of suitable material can include multiple-ply sleeve material, rubber, vinyl, canvas, or the like.

Generally, it is desirable to allow the cover to be secured so as to retain the bumper within the sleeve. This can be accomplished by securing the cover directly to the bumper and/or by enclosing the bumper inside the sleeve (i.e. with closed ends). Thus, a closing mechanism can be oriented at a proximal end of the sleeve. Alternatively, the closing mechanism can be designed to allow a sleeve material to be wrapped around the bumper and secured closed. In this embodiment, the closing mechanism can be oriented along the longitudinal edges of the sleeve (parallel to the bumper) with complimentary ends which can be secured together when wrapped around the bumper. Non-limiting examples of suitable closing mechanisms can include a pair of eyelets, hook and loop fastener (e.g. Velcro), drawstring, zipper, snap, and combinations thereof. FIG. 2 illustrates the use of two opposing grommets or eyelets (32) affixed to one end that correspond to the eyelet of the bumper/dummy, in which a throw rope is secured.

The layer of feathers 28 can be secured to the sleeve using any number of attachment mechanisms. Typically, the bumper covers of the present invention use a plethora of feathers securely attached to woven strings or cords. One option for the attachment member is a cord 30 where feathers are secured to the cord by thread, i.e. tightly trapping ends of feathers between thread wrappings and the cord. Such threaded and strung feathers can be formed similar to a feather boa, albeit for a very different purpose. The feathered cord 30 can then be sewn onto the porous manufactured sleeve 22. Alternatively, the attachment member can be an adhesive where the feathers are directly adhered to the porous manufactured sleeve or via an adhesive tape. A suitable adhesive would maintain the breathability and substantial porosity of the sleeve. For example a thin layer of adhesive can be sprayed onto the sleeve and feathers adhered thereto. In yet another alternative, the attachment member can be integrated with the porous manufactured sleeve such as by embedding the calamus and/or securing mechanisms into the pores of the sleeve. For example, feathers can be poked through the porous material and glued or bound from the inner surface 24 of the sleeve 22. In yet another alternative, the feathers can be sewn together, e.g. by serging or by sewing onto a separate ribbon, cord or other material. The sewn feathers can then be secured to the porous material by any suitable method, e.g. sewing, gluing, etc. Surging of the feathers together before securing to the porous material can allow the feathers to be aligned uniformly and then subsequently secured, for example, in the imbricate bird-like embodiment. Alternatively, the feathers can be sewn into the fabric during the fabric manufacture process such that the feathers are integrated into the fabric. In order to maintain a realistic appearance and to facilitate secure attachment, substantially each feather in the layer of feathers can be attached at a calamus end of each feather, including portions of the afterfeather. Consistent with the above description, a means for attaching a layer of feathers to the outer surface can include a cord which is sewn onto the porous manufactured sleeve, wherein feathers are secured to the cord, an adhesive, or serging thread.

In order to complement different training approaches, the arrangement of feathers can be varied. In one aspect, feathers in the layer of feathers can be randomly arranged, as illustrated in FIG. 2. The present inventor has recognized that a random arrangement of feathers substantially increases the drive of the dog during retrieval training When thrown in the air, random alignment allows for maximum feather movement resulting in high visibility and can improve marking skills of the dog which also encourages increased retrieving drive in the dog. The random feather arrangement also optimizes airflow around the feathers individually, allowing for quick drying, which impedes undesirable fungal and mildew development.

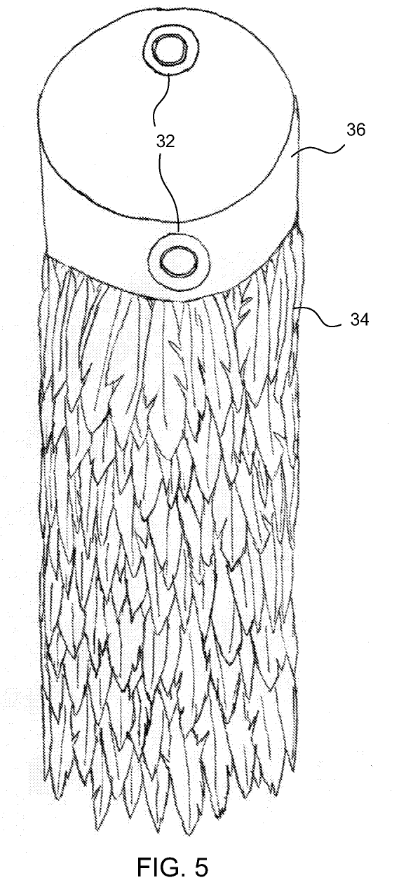

Alternatively, the layer of feathers can include feathers oriented substantially all in a common direction similar to the arrangements found on birds. FIG. 5 illustrates a banded imbricate arrangement of feathers 34 on a parallel plane with the sleeve 36 and bumper/dummy. This arrangement serves to imitate natural feather alignment resulting in a bird like appearance lending realism to the bumper covers of the present invention. This banded imbricate arrangement can be particularly effective when the sleeve is used with bird-shaped dummies as discussed with respect to FIG. 3 and FIG. 4.

The feathers suitable for use can be any material which imitates the appearance of feathers. The use of natural feathers can substantially facilitate scenting and thus reduction of confusion with decoys. Non-limiting examples of suitable natural feathers can include duck, pheasant, goose, partridge, dove, quail, chicken, turkey, etc. Such feathers can be colored, dyed and/or scented and may be used in whole or in part. Alternatively, or in combination, the feathers can be synthetic feathers. Synthetic feathers can be realistic or rough approximations of real feathers. Artificial feathers are commercially available from a wide variety of sources. Non-limiting examples of such artificial feather materials can include those described in European Patent Publication No. EP0045825 or the like. Furthermore, the feathered appearance and feel of these covers has shown to substantially reduce confusion between synthetic decoys and real game.

In yet another optional aspect, the bumper covers can further include at least one of a mildew or mold control agent, antibacterial agent, fungistat, antifungal agent, and water repellant agent coated on at least a portion of the porous manufactured sleeve and/or feathers. Non-limiting examples of suitable mold control agents can include Concrobium®, Microban QGC, Moldstat Plus, and the like. Water repellant agents can include, but are not limited to, anionic fluorocarbons, silicone spray, and the like.

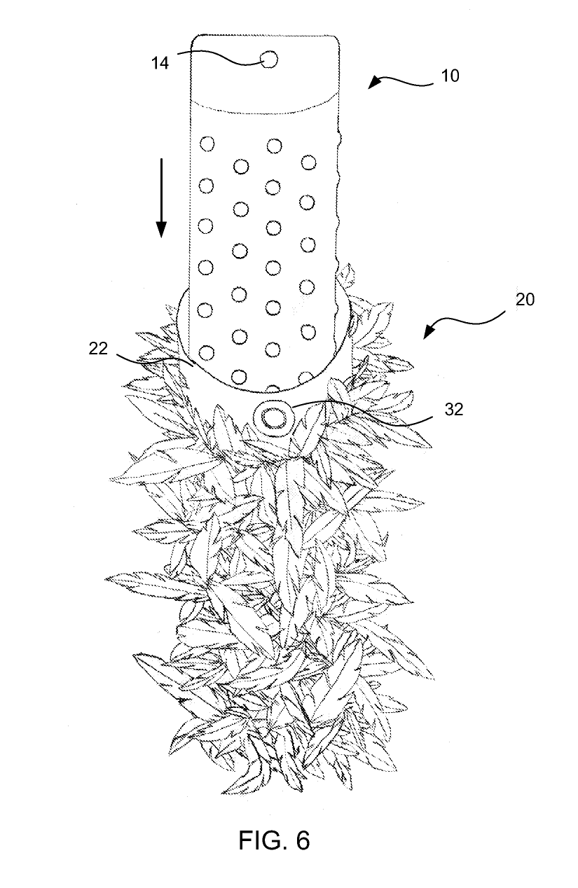

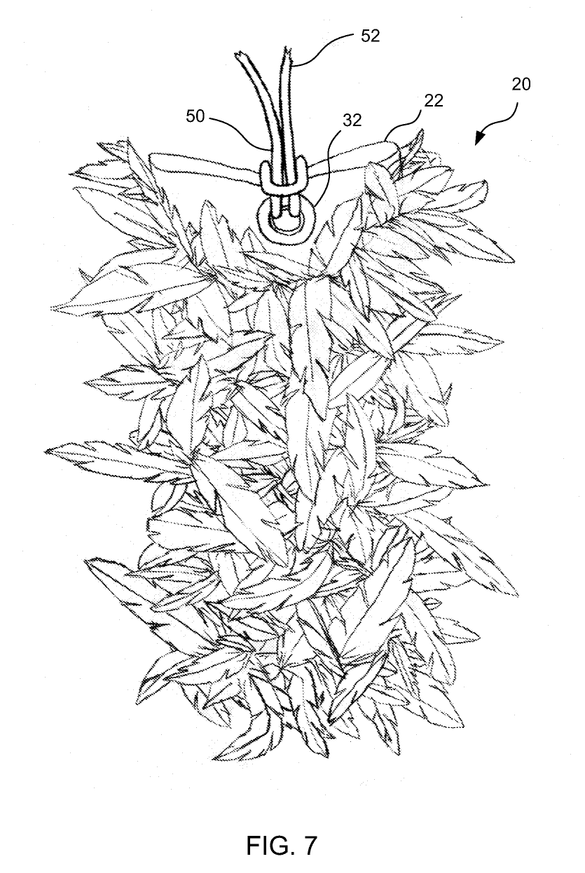

FIG. 6 illustrates a bumper 10 being inserted into a dog training bumper cover 20 in accordance with one embodiment of the present invention. The rubber bumper can be inserted into the sleeve 22 until the eyelet 14 of the bumper lines up with the grommets 32 of the bumper cover. At this point, a length of rope 50 can be tied through the aligned eyelet and grommets 32 to secure the bumper cover over the bumper as illustrated in FIG. 7. Generally, the free end 52 of the length of rope can be sufficient to provide a throwing grip and facilitate slinging of the bumper for retrieval exercises. A toggle ball and/or knot secured at the cord's end can be used to improve grip and throw.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A dog training bumper cover, comprising:
a porous manufactured sleeve having an inner surface and an outer surface and having a layer of feathers attached to the outer surface via an attachment member, wherein the sleeve is configured to at least partially cover a corresponding dog training bumper.

2. The bumper cover of claim 1, wherein the porous manufactured sleeve is a woven fabric, non-woven fabric, screen material, mesh material, or elastic material.

3. The bumper cover of claim 1, wherein porous manufactured sleeve is selected from the group consisting of woven polyethylene fabric, polypropylene fabric, woven polyester fabric, woven cotton fabric, non-woven polypropylene fabric, and combinations thereof.

4. The bumper cover of claim 3, wherein the porous manufactured sleeve is a woven polyethylene fabric.

5. The bumper cover of claim 1, wherein the porous manufactured sleeve is open at a distal end.

6. The bumper cover of claim 1, wherein the porous manufactured sleeve is integral with the corresponding dog training bumper.

7. The bumper cover of claim 1, wherein the porous manufactured sleeve further includes a closing mechanism oriented at a proximal end of the sleeve or along two edges of the sleeve.

8. The bumper cover of claim 7, wherein the closing mechanism is selected from the group consisting of a pair of eyelets, hook and loop fastener, drawstring, zipper, snap, and combinations thereof.

9. The bumper cover of claim 7, wherein the closing mechanism is a pair of eyelets.

10. The bumper cover of claim 1, wherein the attachment member is a cord which is sewn onto the porous manufactured sleeve, wherein feathers are secured to the cord.

11. The bumper cover of claim 1, wherein the attachment member is a thread securing a serging thread holding the plurality of feathers.

12. The bumper cover of claim 1, wherein the attachment member is an adhesive.

13. The bumper cover of claim 1, wherein substantially each feather in the layer of feathers is attached at a calamus end of each feather.

14. The bumper cover of claim 1, wherein the attachment member is integrated with the porous manufactured sleeve.

15. The bumper cover of claim 1, wherein the layer of feathers is randomly arranged.

16. The bumper cover of claim 1, wherein the layer of feathers includes feathers oriented substantially all in a common direction.

17. The bumper cover of claim 1, further including at least one of a mildew control agent, mold control agent, antibacterial agent, antifungal agent, and a water repellant agent coated on at least a portion of at least one of the porous manufactured sleeve and the plurality of feathers.

18. The bumper cover of claim 1, wherein the bumper cover substantially dries within about 12 hours at 25° C. and 50% humidity.

19. A dog training bumper cover, comprising:
a porous manufactured sleeve having an inner surface and an outer surface and a means for attaching a layer of feathers to the outer surface, wherein the sleeve is configured to at least partially cover a corresponding dog training bumper.

20. The bumper cover of claim 19, wherein the means for attaching is one of: a cord which is sewn onto the porous manufactured sleeve, wherein feathers are secured to the cord; an adhesive; and a thread securing a serging thread which holds the layer of feathers.
